(19) United States
(12) Patent Application Publication
(10) Pub. No.: US 2016/0010485 A1
(43) Pub. Date: Jan. 14, 2016

(54) COMBINED CYCLE PROPULSION SYSTEM

(71) Applicant: Aerojet Rocketdyne, Inc., Sacramento, CA (US)

(72) Inventors: Jon Volkmann, Simi Valley, CA (US); Melvin J. Bulman, Fair Oaks, CA (US); Adam Siebenhaar, Shingle Springs, CA (US)

(21) Appl. No.: 14/790,445

(22) Filed: Jul. 2, 2015

Related U.S. Application Data
(60) Provisional application No. 62/022,264, filed on Jul. 9, 2014.

(51) Int. Cl. F01D 15/10; F02K 7/14; F02K 7/16

(52) U.S. Cl. CPC F01D 15/10; F02K 7/16; F02K 7/14

(57) ABSTRACT

A combined cycle propulsion system includes a low-speed propulsion engine and a high-speed propulsion engine that has a compression zone. A non-propulsion turbine is connected with the compression zone. An accessory drive gearbox is mechanically coupled with the low-speed engine and mechanically coupled with the non-propulsion turbine. For example, the low-speed propulsion engine is a turbine engine and the high-speed propulsion engine is a ramjet or scramjet engine.

### CROSS-REFERENCE TO RELATED APPLICATION

The present disclosure claims priority to U.S. Provisional Patent Application No. 62/022,264, filed Jul. 9, 2014.

### BACKGROUND

Combined cycle propulsions systems can be used to achieve high air vehicle speeds. For example, such propulsion systems can include a turbine engine that provides low-speed propulsion and a ramjet or scramjet engine that provides high-speed propulsion.

### SUMMARY

A combined cycle propulsion system according to an example of the present disclosure includes a turbine engine, a ramjet or scramjet engine that has an inlet, a compression zone, a combustion zone, an expansion zone, and an outlet. A secondary turbine has an inlet and an outlet. The inlet of the secondary turbine is fluidly coupled to the compression zone and the outlet of the secondary turbine is fluidly coupled to the turbine engine.

A further embodiment of any of the foregoing embodiments includes an accessory drive gearbox mechanically coupled through a first clutch with the turbine engine and mechanically coupled through a second clutch with the secondary turbine.

In a further embodiment of any of the forgoing embodiments, the accessory drive gearbox is mechanically coupled with at least one of a hydraulic system or an electrical generator.

A further embodiment of any of the foregoing embodiments includes an auxiliary power unit coupled to the accessory drive gearbox, and the auxiliary power unit is configured to start the turbine engine, drive the hydraulic system, and drive the electrical generator.

A further embodiment of any of the foregoing embodiments includes an auxiliary pneumatic power source coupled to the secondary turbine, and the auxiliary pneumatic source is configured to start the turbine engine pneumatically through the secondary turbine.

A further embodiment of any of the foregoing embodiments includes a heat exchanger fluidly connected between the compression zone and the inlet of the secondary turbine inlet.

A combined cycle propulsion system according to an example of the present disclosure includes a low-speed propulsion engine, a high-speed propulsion engine that has a compression zone, a non-propulsion turbine connected with the compression zone, and an accessory drive gearbox selectively mechanically coupled with the low-speed propulsion engine and selectively mechanically coupled with the non-propulsion turbine.

In a further embodiment of any of the forgoing embodiments, the non-propulsion turbine has an outlet that is fluidly connected with the low-speed propulsion engine during a high speed mode.

A further embodiment of any of the foregoing embodiments includes a first clutch selectively mechanically coupling the accessory drive gearbox and the low-speed propulsion engine.

A further embodiment of any of the foregoing embodiments includes a second clutch selectively mechanically coupling the accessory drive gearbox and the non-propulsion turbine.

A further embodiment of any of the foregoing embodiments includes a controller configured to selectively engage and disengage the first clutch and the second clutch with respect to a low-speed mode and a high-speed mode. The low-speed propulsion engine is active and the non-propulsion turbine is inactive in the low-speed mode and the low-speed propulsion engine is inactive and the non-propulsion turbine is active in the high-speed mode.

In a further embodiment of any of the forgoing embodiments, the first clutch is engaged and the second clutch is disengaged in the low-speed mode, and the first clutch is disengaged and the second clutch is engaged in the high-speed mode.

A further embodiment of any of the foregoing embodiments includes a controller configured to selectively engage and disengage the first clutch and the second clutch with respect to a start mode of the low-speed engine.

In a further embodiment of any of the forgoing embodiments, the first clutch is engaged and the second clutch is engaged in the start mode such that rotation of the non-propulsion turbine drives the low-speed propulsion engine through the accessory drive gearbox.

A further embodiment of any of the foregoing embodiments includes a electric generator mechanically coupled with the accessory drive gearbox.

A further embodiment of any of the foregoing embodiments includes a hydraulic system mechanically coupled with the accessory drive gearbox.

A further embodiment of any of the foregoing embodiments includes an auxiliary power unit mechanically coupled with the accessory drive gearbox.

A further embodiment of any of the foregoing embodiments includes a heat exchanger fluidly connected between the compression zone and the non-propulsion turbine.

A method of operating a combined cycle propulsion system according to an example of the present disclosure includes, for a low-speed mode in which a low-speed propulsion engine is active and a high-speed propulsion engine is inactive, engaging a first clutch through which the low-speed propulsion engine is selectively mechanically coupled to an accessory drive gearbox, to drive the accessory drive gearbox using the low-speed propulsion engine, and disengaging a second clutch through which a non-propulsion turbine is selectively mechanically coupled to the accessory drive gearbox. The non-propulsion turbine is connected with a compression zone of the high-speed propulsion engine. For a high-speed mode in which the low-speed propulsion engine is inactive and the high-speed propulsion engine is active, the method includes engaging the second clutch to drive the accessory drive gearbox using the non-propulsion turbine, disengaging the first clutch, driving the non-propulsion turbine with compressed gas from the compression zone, and cooling the low-speed propulsion engine with an exhaust of the non-propulsion turbine.

A further embodiment of any of the foregoing embodiments includes, for a start mode in which the non-propulsion turbine drives the low-speed propulsion engine through the accessory drive gearbox, engaging the first clutch and engaging the second clutch.

A further embodiment of any of the foregoing embodiments includes driving the non-propulsion turbine using an auxiliary power unit.

A further embodiment of any of the foregoing embodiments includes, in both the low-speed mode and the high-speed mode, driving a hydraulic system and a generator from the accessory drive gearbox.

### BRIEF DESCRIPTION OF THE DRAWINGS

The various features and advantages of the present disclosure will become apparent to those skilled in the art from the following detailed description. The drawings that accompany the detailed description can be briefly described as follows. In this disclosure, like reference numerals designate like elements where appropriate and reference numerals with the addition of one-hundred or multiples thereof designate modified elements that are understood to incorporate the same features and benefits of the corresponding elements

FIG. 1 illustrates an example combined cycle propulsion system.

FIG. 2 illustrates another example combined cycle propulsion system that includes an accessory drive gearbox.

FIG. 3 illustrates another example combined cycle propulsion system that includes a gas turbine engine and a ramjet or scramjet engine.

### DETAILED DESCRIPTION

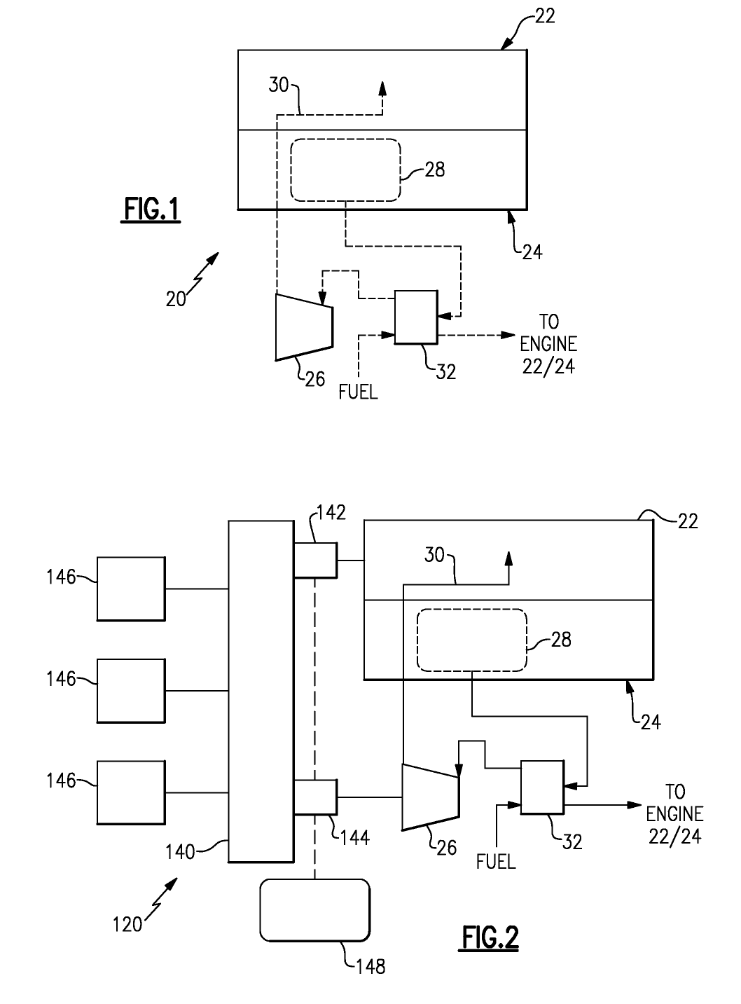

FIG. 1 schematically illustrates an example combined cycle propulsion system 20 (hereafter “propulsion system 20”). Combined cycle propulsion systems can include a (low-speed) turbine propulsion engine and a (high-speed) ramjet or scramjet propulsion engine. For example, the term “low speed” is relative and encompasses airspeeds up to Mach 3.5. The transition points between the different propulsion modes can vary based on the specific vehicle configuration.

During high-speed operation, heat from the ramjet or scramjet propulsion engine and other sources can be conducted into the inactive turbine propulsion engine. Unless the turbine engine is cooled during use of the ramjet or scramjet engine, there is the potential that components of the turbine engine will be exposed to higher temperatures than may be desired. As will be described in further detail, the propulsion system 20 includes features for cooling the turbine propulsion engine, as well as providing additional system functionality.

In the illustrated example, the propulsion system 20 includes a low-speed propulsion engine 22 and a high-speed propulsion engine 24. Generally, the engines 22/24 are of different construction or design and are configured to generate thrust based upon the use of different types of combustion cycles. During operation of the low-speed propulsion engine 22, the high-speed propulsion engine 24 is generally inactive and does not generate thrust. Conversely, during operation of the high-speed propulsion engine 24, the low-speed propulsion engine 22 is generally inactive and does not generate thrust. An arrangement of doors is used to close the air flow path to the low-speed engine during high-speed operation. Typically, the low-speed propulsion engine 22 would be used to initially accelerate a vehicle in the low speed regime (nominally from zero up to Mach 2.5 to 3.5), after which the high-speed propulsion engine 24 can be used to accelerate the vehicle in a high speed regime. At the end of the flight, a transition back to the low speed-speed engine is generally required.

The high-speed propulsion engine 24 generates a considerable amount of heat that can be transferred into the low-speed propulsion engine 22. In this regard, the propulsion system 20 includes a secondary turbine 26 that facilitates cooling the low-speed propulsion engine 22. For example, the secondary turbine 26, which does not itself provide propulsion, is fluidly connected with a compression zone 28 in the high-speed propulsion engine 24. Compressed gas from the compression zone 28 is bled to, and expanded in, the secondary turbine 26. The expansion cools the gas, which is then provided as a coolant gas 30 to the low-speed propulsion engine 22. Although not limited, the coolant gas can be fed through the low-speed propulsion engine 22 to cool airfoils, seals, rotors, and the like. The effectiveness of this coolant flow is enhanced by the closure of the doors on the low speed engine inlet. The above cooling scheme can thus also reduce or eliminate the need to carry secondary coolant aboard the aircraft or vehicle.

Optionally, the propulsion system 20 can also include a heat exchanger 32 between the compression zone 28 and the secondary turbine 26. For example, the heat exchanger 32 is an air-to-fuel heat exchanger. The heat exchanger 32 heats the fuel going to the ramjet or scramjet and initially cools the bleed gas from the compression zone 28 before expansion and further cooling in the secondary turbine 26.

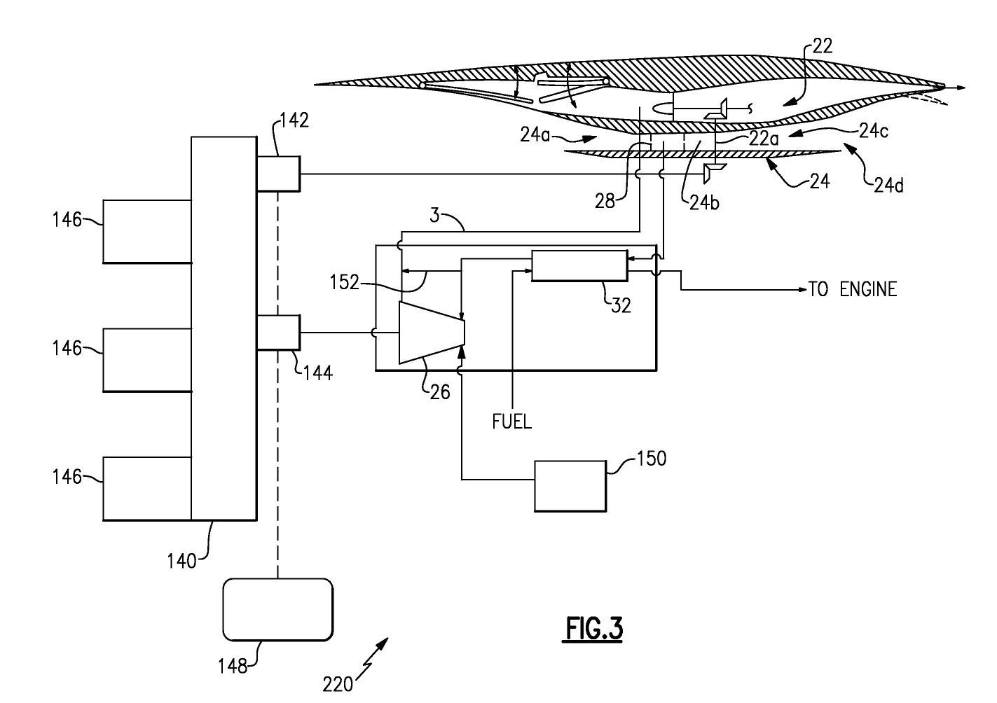

FIG. 2 illustrates another example of a combined cycle propulsion system 120. In this example, the propulsion system 120 additionally includes an accessory drive gearbox 140. This type of gearbox is commonly found in conventional aircraft and provides the means to drive the aircraft's secondary power systems, such as hydraulic pumps or electrical generators. It facilitates the transfer of mechanical power between different systems in the aircraft enabling different modes of operation.

The accessory drive gearbox 140 is selectively mechanically coupled through a first clutch 142 with the low-speed propulsion engine 22, such as by a power take-off shaft 22a of the low-speed propulsion engine 22. In this example the accessory drive gearbox 140 is also selectively mechanically coupled through a second clutch 144 with the secondary turbine 26, such as by a main shaft of the secondary turbine 26. The clutches 142/144 are operable to engage and disengage the mechanical coupling between the accessory drive gearbox 140 and, respectively, the low-speed propulsion engine 22 and the secondary turbine 26.

The accessory drive gearbox 140 is also mechanically coupled to one or more auxiliary systems or devices 146. For example, the one or more auxiliary systems or devices 146 can include a generator, a hydraulic system pump, an auxiliary power unit, or any combination thereof.

The propulsion system 120 further includes a controller 148 that is at least operatively coupled with the clutches 142/144. As can be appreciated, the controller 148 can be in communication with other controllers of an aircraft or vehicle, and/or can be integrated into an existing controller. The controller 148 can include hardware, software, or both, that are configured to carry out the operations described herein.

The controller 148 is operable to engage and disengage each of the clutches 142/144 with respect to various modes of operation of the propulsion system 120. For example, the propulsion system 120 has a low-speed mode and a high-speed mode. In the low-speed mode, the low-speed propulsion engine 22 is active and generates thrust and the high-speed propulsion engine 24 is inactive and does not generate thrust. In the low-speed mode, the controller 148 engages the first clutch 142 disengages the second clutch 144. Thus, the low-speed propulsion engine 22 drives the auxiliary drive gearbox 140 through the first clutch 142 and, in turn, drives the auxiliary systems or devices 146. Since the second clutch 144 is disengaged, the secondary turbine 26, and does not provide any power to the auxiliary drive gearbox 140.

Upon switching from the low-speed mode to the high-speed mode, the low-speed propulsion engine 22 is inactive and the high-speed propulsion engine 24 is active. In this regard, in the high-speed mode, the controller 148 disengages the first clutch 142 and engages the second clutch 144. Thus, the secondary turbine 26 drives the auxiliary drive gearbox 140, and the low-speed propulsion engine 22 does not provide any power to the auxiliary drive gearbox 140. That is, the compressed gas bled from the compression zone 28 drives the secondary turbine 26 which, in turn, drives the auxiliary drive gearbox 140 and auxiliary systems or devices 146. The propulsion system 120 thus enables continuous or substantially continuous powering of the auxiliary systems or devices 146, whether in the low-speed mode or the high-speed mode.

Optionally, the propulsion system 120 may be configured with an additional, start (or restart) mode, for starting the low-speed propulsion engine 22 either on the ground or in-air. In one example of the start mode, the secondary turbine 26 drives the low-speed propulsion engine 22 for light-off/start-up. In this regard, in the start mode the controller 148 engages both clutches 142/144 such that power is input into the auxiliary gearbox 140 from the secondary turbine 26 and output from the auxiliary gearbox 140 to the low-speed propulsion engine 22. A ground-based pneumatic system 150 (FIG. 3) may be configured to drive the secondary turbine 26 in such a start mode.

In another example of the start mode, one of the auxiliary systems or devices 146 is an auxiliary power unit that drives the low-speed propulsion engine 22 for light-off/start-up. For example, the auxiliary power unit includes a jet fuel combustion turbine. In this regard, in the start mode the controller 148 engages the first clutch 142 and disengages the second clutch 144 such that power is input into the auxiliary gearbox 140 from the auxiliary power unit and output from the auxiliary gearbox 140 to the low-speed propulsion engine 22.

FIG. 3 illustrates another example combined cycle propulsion system 220. In this example, the low-speed propulsion engine 22 is a gas turbine engine and the high-speed propulsion engine 24 is a ramjet or scramjet engine. Generally, a gas turbine engine includes a propulsion fan, a multi-stage compressor, a combustor, and a multi-stage turbine that drives the propulsion fan and compressor; and a scramjet includes a converging inlet 24a, the compression zone 28 that serves as a supersonic ramjet compressor, a combustor or combustion zone 24b, and a diverging nozzle 24c through which combustion gas is accelerated to generate thrust/propulsion, and an outlet 24d.

The ramjet or scramjet engine is adjacent the gas turbine engine. Relatively hot gas is bled from the compression zone 28 to the heat exchanger 32 and secondary turbine 26. Optionally, a bypass 152 can be provided to bypass the secondary turbine 26 as a means to regulate the overall performance of the system

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from this disclosure. The scope of legal protection given to this disclosure can only be determined by studying the following claims.

What is claimed is:

1. A combined cycle propulsion system comprising:
a turbine engine;
a ramjet or scramjet engine that has an inlet, a compression zone, a combustion zone, an expansion zone, and an outlet; and
a secondary turbine that has an inlet and an outlet, wherein the inlet of the secondary turbine is fluidly coupled to the compression zone and the outlet of the secondary turbine is fluidly coupled to the turbine engine.

2. The combined cycle propulsion system as recited in claim 1, further comprising an accessory drive gearbox mechanically coupled through a first clutch with the turbine engine and mechanically coupled through a second clutch with the secondary turbine.

3. The combined cycle propulsion system as recited in claim 2, wherein the accessory drive gearbox is mechanically coupled with at least one of a hydraulic system or an electrical generator.

4. The combined cycle propulsion system as recited in claim 3, further comprising an auxiliary power unit coupled to the accessory drive gearbox, and the auxiliary power unit is configured to start the turbine engine, drive the hydraulic system, and drive the electrical generator.

5. The combined cycle propulsion system as recited in claim 1, further comprising an auxiliary pneumatic power source coupled to the secondary turbine, and the auxiliary pneumatic source is configured to start the turbine engine pneumatically through the secondary turbine.

6. The combined cycle propulsion system as recited in claim 1, further comprising a heat exchanger fluidly connected between the compression zone and the inlet of the secondary turbine inlet.

7. A combined cycle propulsion system comprising:
a low-speed propulsion engine;
a high-speed propulsion engine that has a compression zone;
a non-propulsion turbine connected with the compression zone; and
an accessory drive gearbox selectively mechanically coupled with the low-speed propulsion engine and selectively mechanically coupled with the non-propulsion turbine.

8. The combined cycle propulsion system as recited in claim 7, wherein the non-propulsion turbine has an outlet that is fluidly connected with the low-speed propulsion engine during a high speed mode.

9. The combined cycle propulsion system as recited in claim 7, further comprising a first clutch selectively mechanically coupling the accessory drive gearbox and the low-speed propulsion engine.

10. The combined cycle propulsion system as recited in claim 9, further comprising a second clutch selectively mechanically coupling the accessory drive gearbox and the non-propulsion turbine.

11. The combined cycle propulsion system as recited in claim 10, further comprising a controller configured to selectively engage and disengage the first clutch and the second clutch with respect to a low-speed mode and a high-speed mode, wherein the low-speed propulsion engine is active and the non-propulsion turbine is inactive in the low-speed mode and the low-speed propulsion engine is inactive and the non-propulsion turbine is active in the high-speed mode.

12. The combined cycle propulsion system as recited in claim 11, wherein the first clutch is engaged and the second clutch is disengaged in the low-speed mode, and the first clutch is disengaged and the second clutch is engaged in the high-speed mode.

13. The combined cycle propulsion system as recited in claim 10, further comprising a controller configured to selectively engage and disengage the first clutch and the second clutch with respect to a start mode of the low-speed engine.

14. The combined cycle propulsion system as recited in claim 13, wherein the first clutch is engaged and the second clutch is engaged in the start mode such that rotation of the non-propulsion turbine drives the low-speed propulsion engine through the accessory drive gearbox.

15. The combined cycle propulsion system as recited in claim 7, further comprising a electric generator mechanically coupled with the accessory drive gearbox.

16. The combined cycle propulsion system as recited in claim 7, further comprising a hydraulic system mechanically coupled with the accessory drive gearbox.

17. The combined cycle propulsion system as recited in claim 7, further comprising an auxiliary power unit mechanically coupled with the accessory drive gearbox.

18. The combined cycle propulsion system as recited in claim 7, further comprising a heat exchanger fluidly connected between the compression zone and the non-propulsion turbine.

19. A method of operating a combined cycle propulsion system, the method comprising:
for a low-speed mode in which a low-speed propulsion engine is active and a high-speed propulsion engine is inactive, engaging a first clutch through which the low-speed propulsion engine is selectively mechanically coupled to an accessory drive gearbox, to drive the accessory drive gearbox using the low-speed propulsion engine, and disengaging a second clutch through which a non-propulsion turbine is selectively mechanically coupled to the accessory drive gearbox, the non-propulsion turbine being connected with a compression zone of the high-speed propulsion engine;
for a high-speed mode in which the low-speed propulsion engine is inactive and the high-speed propulsion engine is active, engaging the second clutch to drive the accessory drive gearbox using the non-propulsion turbine, disengaging the first clutch, and driving the non-propulsion turbine with compressed gas from the compression zone; and
cooling the low-speed propulsion engine with an exhaust of the non-propulsion turbine.

20. The method as recited in claim 19, further comprising, for a start mode in which the non-propulsion turbine drives the low-speed propulsion engine through the accessory drive gearbox, engaging the first clutch and engaging the second clutch.

21. The method as recited in claim 20, further comprising driving the non-propulsion turbine using an auxiliary power unit.

22. The method as recited in claim 19, further comprising, in both the low-speed mode and the high-speed mode, driving a hydraulic system and a generator from the accessory drive gearbox.
